(19) United States
(12) Patent Application Publication
(10) Pub. No.: US 2023/0178706 A1
(43) Pub. Date: Jun. 8, 2023

(54) ELECTRODE MANUFACTURING METHOD

(71) Applicant: TOYOTA JIDOSHA KABUSHIKI KAISHA, Toyota-shi (JP)

(72) Inventors: Shugo DAIKUHARA, Nisshin-shi (JP); Takenori IKEDA, Owariasahi-shi (JP); Satoshi MORIYAMA, Nagoya-shi (JP); Takeshi KONDO, Kariya-shi (JP); Tomoyuki TASAKI, Kariya-shi (JP); Tomokuni ABE, Kariya-shi (JP)

(73) Assignee: TOYOTA JIDOSHA KABUSHIKI KAISHA, Toyota-shi (JP)

(21) Appl. No.: 17/953,876

(22) Filed: Sep. 27, 2022

(30) Foreign Application Priority Data
Dec. 3, 2021 (JP) 2021-196851

(51) Int. Cl. H01M 4/04

(52) U.S. Cl. CPC H01M 4/0416

(57) ABSTRACT

An electrode manufacturing method includes (a) preparing a first electrode including a first current collector and a first active material layer, (b) separating the first current collector and the first active material layer, (c) processing the first active material layer into wet particles, (d) shaping the wet particles into a second active material layer and (e) disposing the second active material layer on a surface of a second current collector, thereby manufacturing a second electrode. The first active material layer includes an active material and a binder. The second active material layer includes the active material and the binder.

### CROSS-REFERENCE TO RELATED APPLICATION

This application claims priority to Japanese Patent Application No. 2021-196851 filed on Dec. 3, 2021, incorporated herein by reference in its entirety.

### BACKGROUND

### 1. Technical Field

The present disclosure relates to an electrode manufacturing method.

### 2. Description of Related Art

Japanese Unexamined Patent Application Publication No. 2014-127417 (JP 2014-127417 A) discloses a method for recovering and reusing an anode active material of a lithium-ion battery.

### SUMMARY

There is demand for recycling electrode materials. A reason thereof is that electrode materials may contain rare materials. Generally, electrodes include a current collector and an active material layer. The active material layer is adhered to a surface of the current collector. A main component of the active material layer is an active material. Remanufacturing electrodes by using active materials recovered from active material layers has been proposed.

Generally, the active material layer also includes a binder. The binder is firmly adhered to the active material. In order to separate the active material and the binder, there are cases in which lengthy separation processing is required, for example. In the separation processing, the active material may be immersed in a heated solvent, for example. There is a possibility that the active material may be altered or deteriorate due to the separation processing.

Generally, the active material layer is formed by coating with a slurry (particle dispersion liquid). That is to say, a slurry is produced by dispersing an active material or the like in a solvent. The active material layer can be formed by coating the slurry on the surface of the current collector.

The binder can firmly bind the active materials to each other. When separation between the active material and the binder is inadequate, the active material can form coarse aggregates. When a slurry containing coarse aggregates is coated, surface defects (coating film defects) such as streaks, for example, may frequently occur.

The present disclosure provides a method for remanufacturing electrodes.

Technical configurations and advantageous effects of the present disclosure are described below. Note however, that an mechanism of action according to the present specification includes estimation. The mechanism of action does not limit the technical scope of the present disclosure.

An electrode manufacturing method according to a first aspect of the present disclosure includes
(a) preparing a first electrode including a first current collector and a first active material layer,
(b) separating the first current collector and the first active material layer,
(c) processing the first active material layer into wet particles,
(d) shaping the wet particles into a second active material layer and
(e) disposing the second active material layer on a surface of a second current collector, such that a second electrode is manufactured. The first active material layer includes an active material and a binder, and the second active material layer includes the active material and the binder.

In the present disclosure, the second electrode is manufactured using the first active material layer as a raw material. The first active material layer is processed into wet particles. The first active material layer includes an active material and a binder. That is to say, the active material and the binder are reused together. Accordingly, in the present disclosure, the separation processing of the active material and the binder can be reduced.

The wet particles are particles in a wet state. The particles adhere to each other in the wet particles, due to being in a wet state. That is to say, the wet particles can originally contain aggregates of active material. Accordingly, in the present disclosure, the process of crushing the aggregates can be simplified.

For example, in slot-die coating of a slurry, surface defects such as streaks may occur due to a slurry discharge port becoming clogged with aggregates. Accordingly, when a slurry is used, crushing the aggregates is necessary. Conversely, a wet particles can be shaped into a sheet. That is to say, the active material layer is formed by a shaping process. In the shaping process, the aggregates are processed from being granular to being film-like. A lower likelihood of surface defects, such as streaks, is anticipated with shaping processing of wet particles, as compared to coating with slurry.

In the electrode manufacturing method according to the first aspect of the present disclosure, a solid content fraction of the wet particles may be 70% or more.

In the electrode manufacturing method according to the first aspect of the present disclosure, when the wet particles are shaped into the second active material layer, the wet particles may be shaped into a sheet by roll forming.

In the electrode manufacturing method according to the first aspect of the present disclosure, the first active material layer may further include an electroconductive material, and the second active material layer may further include the electroconductive material.

In the electrode manufacturing method according to the first aspect of the present disclosure, the first active material layer and a solvent may be mixed when the first active material layer is processed into the wet particles.

The active material, the binder, and the electroconductive material may be reused together.

An embodiment of the present disclosure (hereinafter, may be abbreviated to “present embodiment”) and an example of the present disclosure (hereinafter, may be abbreviated as “present example”) will be described below. Note however, that the present embodiment and the present example do not limit the technical scope of the present disclosure.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic flowchart of an electrode manufacturing method according to an embodiment.

FIG. 2 is a schematic view illustrating an example of an electrode manufacturing apparatus.

### DETAILED DESCRIPTION OF EMBODIMENTS

Definition of Terms, etc.

In the present specification, the terms “comprise,” “include,” “have,” and variations thereof (e.g., “composed of”) are open-ended. Additional elements may or may not be included in addition to essential elements in open-ended terms. The term “consist of” is closed-ended. However, even closed-ended terms do not exclude normally-associated impurities and additional elements that are irrelevant to the technology according to the present disclosure. The term “substantially consist of” is semi-closed-ended. Semi-closed-ended terms allow addition of elements that do not substantially affect the basic and novel characteristics of the technology according to the present disclosure.

In the present specification, the words such as “may” and “can” are used in a permissive sense, meaning that “it is possible,” rather than in a mandatory sense, meaning “must.”

In the present specification, the order of execution of a plurality of steps, actions, operations, or the like, included in various types of methods, is not limited to the order described, unless otherwise specified. For example, the steps may be ongoing at the same time. Also, for example, the order of the steps may be inverted.

In the present specification, numerical ranges such as “m % to n %”, for example, include upper and lower limit values thereof unless otherwise specified. That is to say, “m % to n %” indicates the numerical range of “m % or more and n % or less.” Further, “m % or more and n % or less” includes “more than m % and less than n %.” Further, a numerical value optionally selected from within a numerical range may be set as a new upper limit value or a new lower limit value. For example, a new numerical range may be set by optionally combining a numerical value in the numerical range and a numerical value described in a different part of the present specification, a table, the drawings, or the like.

In the present specification, all numerical values should be interpreted as being preceded by the term “about”. The term “about” can mean, for example, ±5%, ±3%, ±1%, or the like. All numerical values can be approximate values that can vary depending on the manner in which the technology according to the present disclosure is used. All numerical values can be expressed in significant figures. A measured value can be an average value of a plurality of measurements. The number of measurements may be three or more, may be five or more, or may be ten or more. Generally, the larger the number of measurements is, the higher the reliability of the average value is anticipated to be. Measured values can be rounded off, based on the number digits of significant figures. Measured values can include error and so forth, due to detection limits and so forth of measuring devices, for example.

In the present specification, when a compound is represented by a stoichiometric composition formula (e.g., “LiCoO₂” etc.), the stoichiometric composition formula is merely a representative example of the compound. Compounds may have a non-stoichiometric composition. For example, when lithium cobalt oxide is represented by “LiCoO₂,” the lithium cobalt oxide is not limited to the composition ratio of “Li/Co/O=1/1/2” and may contain lithium (Li), cobalt (Co), and oxygen (O) at any composition ratio, unless otherwise specified. Furthermore, doping, substitution, and so forth, by trace elements, are allowable.

The “first active material layer” in the present specification includes a first active material layer recovered as sheets, flakes, or granular material.

The term “solid content fraction” in the present specification indicates the mass fraction of a solid component in paints and so forth (e.g., slurry, wet particles, active material layer, or the like). Note that a solute dissolved in a solvent is regarded as a solid component.

The term “electrode” as used in the present specification is a collective term for cathodes and anodes. The electrode may be a cathode or may be an anode. The electrode may be applied to optional usages. The electrode may be for a battery, for example. In the present specification, an electrode for a lithium-ion battery will be described, as one example.

In the present specification, D50 of the active material indicates a particle size in which the cumulative frequency in order from the smallest particle sizes reaches 50% in a volume-based particle size distribution. The volume-based particle size distribution can be measured by laser diffraction scattering.

In the present specification, D50 of the wet particles indicates a particle size in which the cumulative frequency in order from the smallest particle sizes reaches 50% in a mass (count)-based particle size distribution. The mass-based particle size distribution can be measured in accordance with “JIS Z8815 Test sieving — General requirements”.

Electrode Manufacturing Method

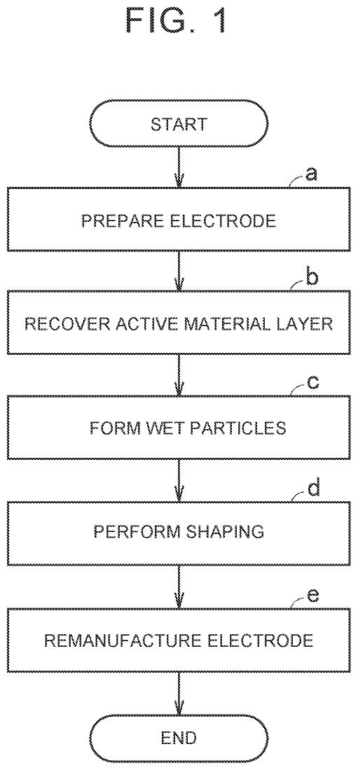

FIG. 1 is a schematic flowchart of an electrode manufacturing method according to an embodiment. Hereinafter, the phrase, “electrode manufacturing method according to the present embodiment” may be abbreviated to “present manufacturing method”. The present manufacturing method includes “(a) preparation of electrode”, “(b) recovery of active material layer”, “(c) formation of wet particles”, “(d) shaping”, and “(e) remanufacturing of electrode”.

(a) Preparation of Electrode

The present manufacturing method includes preparing a first electrode including a first current collector and a first active material layer. The first electrode can be prepared by any method. For example, the electrode may be recovered by disassembling a battery. A used battery may be disassembled, or an unused battery may be disassembled. For example, defective products, cutting scraps, and so forth, which are created during manufacturing of the electrode, may be recovered as the first electrode.

The first electrode can have any form. The first electrode may be in the form of a sheet, for example. The first electrode includes a first current collector and a first active material layer. The first active material layer is disposed on a surface of the first current collector. The first active material layer may be disposed on only one side of the first current collector, or may be disposed on both front and rear sides thereof.

The first current collector may contain metal foil, metal mesh, porous metal, or the like, for example. The first current collector may contain, for example, at one type selected from a group consisting of aluminum (Al) foil, Al alloy foil, copper (Cu) foil, Cu alloy foil, titanium (Ti) foil, stainless steel (SS) foil, nickel (Ni) plated SS foil, Ni foil, Ni mesh, and Ni porous material.

The first active material layer may be a layer formed from a slurry or may be a layer formed from wet particles. The first active material layer contains an active material and a binder. In the present manufacturing method, the active material and the binder may be reused together.

The active material may be in the form of particles, for example. The active material may have a D50 of 0.5 μm to 50 μm or a D50 of 1 μm to 10 μm, for example.

The active material may contain a cathode active material. The cathode active material may contain at least one type selected from a group consisting of, for example, LiCoO₂, LiNiO₂, LiMnO₂, LiMn₂O₄, Li(NiCoMn)O₂, Li(NiCoAl)O₂, and LiFePO₄. The “(NiCoMn)” in “Li (NiCoMn)O₂” indicates that the total composition ratio inside the parentheses is 1. Amounts of individual components are optional as long as the total is 1. Li(NiCoMn)O₂ may include, for example, Li(Ni_{1/3}Co_{1/3}Mn_{1/3})O₂, Li(Ni_{0.5}Co_{0.2}Mn_{0.3})O₂, Li(Ni_{0.8}Co_{0.1}Mn_{0.1})O₂, and so forth. The active material may contain an anode active material. The anode active material may contain at least one type selected from a group consisting of, for example, graphite, soft carbon, hard carbon, silicon, silicon oxide, silicon-based alloys, tin, tin oxide, tin-based alloys, and Li₄Ti₅O₁₂.

The amount of the binder that is contained may be, for example, 0.1 to 10 parts by mass, with respect to 100 parts by mass of the active material. The binder may contain any component. The binder may contain at least one type selected from a group consisting of, for example, polyvinylidene difluoride (PVDF), polyvinylidene difluoride — hexafluoropropylene copolymer (PVDF-HFP), polytetrafluoroethylene (PTFE), styrene butadiene rubber (SBR), carboxymethyl cellulose (CMC), polyacrylic acid (PAA), polyamide-imide (PAI), and polyimide (PI).

The first active material layer may further contain an electroconductive material, a solid electrolyte, and so forth. In the present manufacturing method, the active material, the binder, the electroconductive material, the solid electrolyte, and so forth, may be reused together. That is to say, in the present manufacturing method, the electrode composite material can be reused.

The amount of the electroconductive material that is contained may be, for example, 0.1 to 10 parts by mass, with respect to 100 parts by mass of the active material. The electroconductive material may contain, for example, electroconductive carbon particles, electroconductive carbon fibers, and so forth. The electroconductive material may contain at least one type selected from a group consisting of, for example, carbon black, vapor-grown carbon fibers (VGCF), carbon nanotubes (CNT), and graphene flakes.

The carbon black may contain at least one type selected from a group consisting of, for example, acetylene black, Ketjen black (a registered trademark), furnace black, channel black, and thermal black.

The amount of the solid electrolyte that is contained may be, for example, 1 to 100 parts by volume with respect to 100 parts by volume of the active material. The solid electrolyte may contain at least one type selected from a group consisting of, for example, Li₂S-P₂S₅, LiI-Li₂S-P₂S₅, LiBr-Li₂S-P₂S₅, and LiI-LiBr-Li₂S-P₂S₅.

(b) Recovery of Active Material Layer

The present manufacturing method includes separating the first current collector and the first active material layer. Thus, the first active material layer is recovered. The first active material layer can be recovered in any form. For example, the first active material layer may be recovered as a sheet, may be recovered as flakes, or may be recovered as a granular material.

The first active material layer can be separated from the first current collector by any method. For example, the first active material layer may be peeled off from the first current collector by a scraper or the like. For example, the first active material layer may be peeled off from the first current collector by applying ultrasonic vibrations to the first electrode. A solvent may be dispersed upon the first active material layer, for example, in order to promote separation between the first active material layer and the first current collector. Also, for example, the first electrode may be stored in a high-humidity environment. Note that the first current collector may also be reused.

(c) Formation of Wet Particles

The present manufacturing method includes processing the first active material layer into wet particles. For example, wet particles may be formed by mixing the first active material layer and a solvent. The solvent can be selected in accordance with the type of binder or the like, for example. The solvent may include at least one type selected from a group consisting of, for example, water, N-methyl-2-pyrrolidone (NMP), alcohol (e.g., ethanol, propanol, or the like), and ester (e.g., butyl butyrate, etc.).

The first active material layer and the solvent may be mixed by an agitating granulator, for example. The wet particles may be crushed or may be granulated. For example, a planetary mixer, a three roll mill, or the like, may be used. One-step mixing may be carried out, or multi-step mixing may be carried out. Wet particles may be formed by mixing the first active material layer and the solvent in a planetary mixer, for example. The wet particles may be kneaded by a three roll mill.

The wet particles may be created so as to have a solid content fraction of 70% or more, for example. The wet particles may be created so as to have a solid content fraction of 70% to 90%, for example. The wet particles may be created so as to have a solid content fraction of 75% to 85%, for example.

The wet particles can be granular, flake-like, clay-like or the like. The properties of the wet particles can be adjusted by the solid content fraction, the mixing conditions, and so forth, for example.

The wet particles may be created so as to have a D50 of 4 mm or less, for example. The wet particles may be created so as to have a D50 of 0.1 mm to 4 mm, or may be created so as to have a D50 of 0.5 mm to 2 mm, for example.

(d) Shaping

The present manufacturing method includes shaping the wet particles into a second active material layer. The second active material layer is sheet-like. In the present manufacturing method, any shaping processing can be carried out. For example, the wet particles may be shaped into a sheet by roll forming.

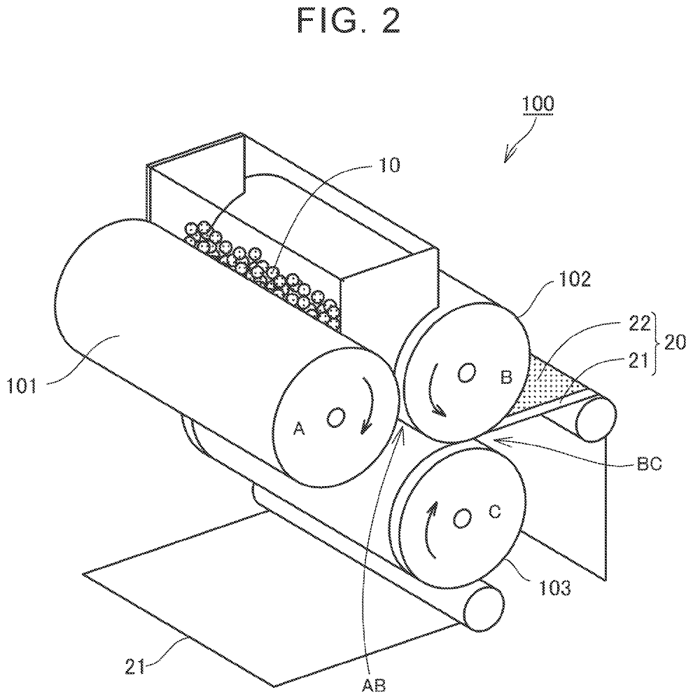

FIG. 2 is a schematic view illustrating an example of an electrode manufacturing apparatus. The electrode manufacturing apparatus 100 can manufacture electrodes by roll-to-roll processing. The electrode manufacturing apparatus 100 can carry out roll shaping and roll transfer.

The electrode manufacturing apparatus 100 includes a first roll 101, a second roll 102, and a third roll 103. The rolls rotate in the directions indicated by arrows. Axes of rotation of the rolls are parallel. A relation of “w1<w2<w3” may be satisfied when a rotation speed of the first roll 101 is w1, a rotation speed of the second roll 102 is w2, and a rotation speed of the third roll 103 is w3, for example.

A gap AB is formed between the first roll 101 and the second roll 102. Wet particles 10 are supplied to the gap AB. A second active material layer 22 (sheet) is formed by compacting the wet particles 10 in the gap AB. The second active material layer 22 contains an active material and a binder. The active material and the binder were contained in the first active material layer. The second active material layer 22 may further contain an electroconductive material, a solid electrolyte, and so forth.

(e) Remanufacturing of Electrode

The present manufacturing method includes manufacturing a second electrode 20 by disposing the second active material layer 22 on a surface of a second current collector 21. A gap BC is formed between the second roll 102 and the third roll 103. The second roll 102 conveys the second active material layer 22 to the gap BC (see FIG. 2). The third roll 103 conveys the second current collector 21 to the gap BC. The second current collector 21 may be made of the same material as that of the first current collector, or may be made of a different material.

At the gap BC, the second active material layer 22 is rubbed against the surface of the second current collector 21. Thus, the second active material layer 22 adheres to the surface of the second current collector 21. The second electrode 20 is manufactured by adhesion of the second active material layer 22 to the second current collector 21. That is to say, the electrode is remanufactured.

After disposing the second active material layer 22, the second electrode 20 may be dried. The second electrode 20 may be compressed in accordance with the usage. The second electrode 20 may be cut in accordance with the usage. The second electrode 20 may have the same specifications as the first electrode, or may have different specifications.

### EXAMPLES

A cathode was prepared as the first electrode. The first electrode included the first current collector and the first active material layer. The first current collector foil was aluminum foil (12 μm thick). The composition of the first active material layer was “LiFePO₄/CNT/CMC/SBR=95.5/2/1.2/1.3 (mass ratio)”.

The first active material layer was scraped from the first current collector by a scraper. Thus, the first active material layer was recovered. The solid content fraction of the first active material layer was measured by the dry weight method. A planetary mixer was prepared. The first active material layer and the solvent (ion-exchanged water) were placed in an agitation tank of the planetary mixer. Wet particles were produced by mixing the first active material layer and the solvent by the planetary mixer. A three roll mill was prepared. The wet particles were kneaded by the three roll mill. The solid content fraction of the wet particles was 78%.

The electrode manufacturing apparatus 100 was prepared (see FIG. 2). The wet particles 10 were shaped into the second active material layer 22 by roll forming. The second active material layer 22 was transferred to the second current collector 21 (aluminum foil 12 μm thick), thereby the second electrode 20 is manufactured.

The surface quality of the second active material layer 22 was visually confirmed. No surface defects such as streaks were found to be formed on the second active material layer 22.

### Comparative Example

As a comparative example, a method similar to the technology disclosed in JP 2014-127417 A was experimentally carried out. Samples No. 1 to No. 9 were prepared as first electrodes (see Table 1 below). The samples No. 1 to No. 9 were cathodes. In the samples No. 1 to No. 9, the first active material layer had a first composition or a second composition. The second composition differs from the first composition in that SBR is not contained therein. SBR has a firmer binding force than CMC. The initial D50 of the active material was 1.3 μm.

The first active material layer was recovered by immersing the sample in a solvent (ion-exchanged water). Separation processing of the first active material layer and the binder and so forth was performed. That is to say, ultrasonic vibrations were applied to the first active material layer in the solvent by an ultrasonic homogenizer. The conditions for the separation processing are shown in Table 1 below.

After the separation processing, the D50 of the active material was measured by a wet particle size distribution analyzer (product name “MT3300”, manufactured by Microtrac Bell Co., Ltd.). Ion-exchanged water was used as a dispersion medium. The closer the D50 is to the initial value (1.3 μm), the more the separation is considered to be progressing.

Following measurement of the D50, a slurry containing the active material was made. The slurry was coated onto the surface of the second current collector by a die coater. Thus, the second active material layer was formed. That is to say, the second electrode was manufactured.

Surface quality of the second active material layer was visually confirmed. The confirmation results are shown in Table 1 below.

TABLE 1

| | | Separation | | | Following | Second active |
|---|---|---|---|---|---|---|
| | | processing | | | separation | material layer |
| | First active | | Ultrasonic | | processing | (Slurry coating) |
| | material | Solvent | vibrations | Processing | Active | Surface quality |
| Sample | layer | temperature | Frequency | time | material ²⁾ | (Presence/absence |
| No. | Composition ¹⁾ | (° C.) | (kHz) | (h) | D50 (μm) | of streaks, etc.) |
| 1 | First composition | 25 | 20 | 1 | 11.4 | Present |
| 2 | First composition | 25 | 20 | 4 | 7.3 | Present |
| 3 | First composition | 25 | 20 | 8 | 5.7 | Present |
| 4 | First composition | 50 | 20 | 1 | 6.2 | Present |
| 5 | First composition | 50 | 20 | 4 | 2.9 | Present |
| 6 | First composition | 50 | 20 | 8 | 1.6 | Absent |
| 7 | Second composition | 25 | 20 | 1 | 3.2 | Present |
| 8 | Second composition | 25 | 20 | 4 | 1.6 | Absent |
| 9 | Second composition | 25 | 20 | 8 | 1.5 | Absent |

¹⁾ First composition: LiFeP0_{4/}CNT/CMC/SBR = 95.5/2/1.2/1.3 (mass ratio)
Second composition: LiFeP0_{4/}CNT/CMC/SBR = 96.8/2/1.2/0 (mass ratio)
²⁾ Initial value of D50 (value before forming the first active material layer) was 1.3 μm.

In No. 1 to No. 3, the D50 after the separation processing was large. Separation between the active material and the binder is thought to have been insufficient, even though ultrasonic vibration was applied in the solvent at 25° C. In No. 1 to No. 3, surface defects such as streaks and so forth frequently occurred when the second active material layer is formed. Coarse aggregates are thought to have formed in the active material.

The D50 following the separation processing was smaller in No. 4 to No. 6 than in No. 1 to No. 3. The separation is thought to have been promoted by increasing the temperature of the solvent. However, lengthy processing is thought to be necessary in order for the active material and the binder to be sufficiently separated (see No. 6).

In No. 7 to No. 9 (second composition), the active material and the binder were separated in a relatively short time. The binding force is thought to have been weak, due to the binder not containing SBR. However, practical peeling strength is thought to be unobtainable by the second composition, since the binding force of the binder is weak.

The present embodiment and the present example are exemplary in all respects. The present embodiment and the present example do not limit the technical scope of the present disclosure. The technical scope of the present disclosure encompasses all modifications within the meaning and scope equivalent to those of the claims. For example, extracting optional configurations from the present embodiment and the present example and making optional combinations thereof is originally planned.

What is claimed is:

1. An electrode manufacturing method comprising:
(a) preparing a first electrode including a first current collector and a first active material layer;
(b) separating the first current collector and the first active material layer;
(c) processing the first active material layer into wet particles;
(d) shaping the wet particles into a second active material layer; and
(e) disposing the second active material layer on a surface of a second current collector, such that a second electrode is manufactured, wherein the first active material layer includes an active material and a binder, and the second active material layer includes the active material and the binder.

2. The electrode manufacturing method according to claim 1, wherein a solid content fraction of the wet particles is 70% or more.

3. The electrode manufacturing method according to claim 1, wherein, when the wet particles are shaped into the second active material layer, the wet particles are shaped into a sheet by roll forming.

4. The electrode manufacturing method according to claim 1, wherein the first active material layer further includes an electroconductive material, and the second active material layer further includes the electroconductive material.

5. The electrode manufacturing method according to claim 1, wherein the first active material layer and a solvent are mixed when the first active material layer is processed into the wet particles.
